(19) United States
(12) Patent Application Publication
(10) Pub. No.: US 2026/0280238 A1
(43) Pub. Date: Sep. 17, 2026

(54) RETROFIT MICROGRID INTERCONNECT DEVICE (MID) AND BRANCH CONTROL RELAYS INTO ELECTRICAL PANELS

(71) Applicant: Schneider Electric USA, Inc., Andover, MA (US)

(72) Inventor: Chad R. Mittelstadt, Cedar Rapids, IA (US)

(73) Assignee: Schneider Electric USA, Inc., Boston, MA (US)

(21) Appl. No.: 19/076,290

(22) Filed: Mar. 11, 2025

(51) Int. Cl. H02B 1/056; H02B 1/20

(52) U.S. Cl. CPC H02B 1/056; H02B 1/20

(57) ABSTRACT

A method of new installation or retrofitting an electrical panel includes removing an interior from a panel housing of the electrical panel. The method includes installing a microgrid interconnect device (MID) into the panel housing into a position formerly occupied by the interior, connecting first and second lines and a neutral line of the panel housing to the MID, and installing the interior onto the MID, with the MID between the interior and a back surface of the panel housing. The method includes connecting respective busses of the interior to the MID. Branch switching devices of the MID are connected in electrical series with respective branch breakers of the interior for individual control of branch circuits.

### BACKGROUND

### 1. Field

The present disclosure relates to electrical panels, and more particularly to microgrid interconnect devices (MID's) for connecting and disconnecting residential electrical panels such as common service entrance device (CSED) panels from utility grids.

### 2. Description of Related Art

It is common for CSED panels to need an MID, but there is no provision to add an MID to a CSED panel easily. One solution has been to locate an MID inside the meter collar, but that location is not always compliant with utility regulations. Ideally, there would be enough room in the CSED panel itself to locate an MID physically in between the main breaker and the interior. However in legacy CSED configurations there is not enough room in the vertical direction to fit an MID physically. While there are some new install options for accommodating MID's in CSED panels, they do not solve the problem of retrofitting legacy CSED panels to include MID's. Existing retrofit solutions require relocating the branch breakers, which is not ideal.

The conventional techniques have been considered satisfactory for their intended purpose. However, there is an ever-present need for improved systems and methods for incorporating MID's with CSED panels, including methods for retrofitting legacy CSED panels to include MID's. This disclosure provides a solution for this need.

### SUMMARY

A method of retrofitting an electrical panel includes removing an interior from a panel housing of the electrical panel. The method includes installing a microgrid interconnect device (MID) into the panel housing into a position formerly occupied by the interior, connecting first and second lines and a neutral line of the panel housing to the MID, and installing the interior onto the MID, with the MID between the interior and a back surface of the panel housing. The method includes connecting respective busses of the interior to the MID, and connecting a branch switching device, e.g. relay, of the MID in electrical series with a branch breaker of the interior for control of a branch circuit.

Prior to removing the interior from the panel housing, the method can include unplugging a plurality of branch devices from the buses of the interior. After installing the interior onto the MID, the method can include re-installing the branch devices to the busses of the interior. Each of the branch devices can be a branch breaker. Connecting the branch switching device of the MID in electrical series with the branch breaker of the interior can include (for each branch) breaker: disconnecting a first wire connecting a respective branch circuit to the branch breaker from the branch breaker; connecting the first wire to a first lug of a respective branch switching device of the MID; and connecting a jumper wire from a second lug of the respective branch switching device to the branch breaker.

The branch breaker can be a 2-pole circuit breaker. Connecting the branch switching device of the MID in electrical series with a branch breaker can include: disconnecting a first wire connecting the branch circuit to the branch breaker from a first lug of the branch breaker; connecting the first wire to a first lug of a first branch switching device of the MID; connecting a first jumper wire from a second lug of the first branch switching device of the MID to the first lug of the branch breaker; disconnecting a second wire connecting the branch circuit to the branch breaker from a second lug of the branch breaker; connecting the second wire to a first lug of a second branch switching device of the MID; and connecting a second jumper wire from a second lug of the second branch switching device of the MID to the second lug of the branch breaker.

Prior to removing the interior from the panel housing, the method can include removing a deadfront from the panel housing to provide access to an interior of the electrical panel. After connecting respective busses of the interior to the MID, the method can include re-installing the deadfront or installing a new deadfront to the panel housing. The method can include connecting an external device a communication port of the MID.

A microgrid interconnect device (MID) includes a main switching device. A first line connector is electrically connected to the main switching device and is configured to connect to a first line of an electrical panel. A second line connector is electrically connected to the main switching device and is configured to connect to a second line of the electrical panel. A first load connector is electrically connected to the main switching device and is configured to connect to a first line bus of an interior of the electrical panel. A second load connector is electrically connected to the main switching device and is configured to connect to a second line bus of the interior. The main switching device is configured to switch back and forth between an ON state and an OFF state. In the ON state, the main switching device electrically connects the first line connector to the first load connector and electrically connects the second line connector to the second load connector. In the OFF state, the main switching device electrically isolates the first line connector from the first load connector and electrically isolates the second line connector from the second load connector. A plurality of branch switching devices are operatively connected to the main switching device to control individual branch circuits.

A housing can be included. The main switching device can be in an interior space of the housing. Each of the first load connector, the second load connector, the first line connector, and the second line connector can extend from an exterior space, through the housing, and into the interior space of the housing. A neutral line connector can be mounted to the housing. The neutral line connector can be configured to connect to a neutral line of the electrical panel to a neutral bus of the interior. The housing can include a back surface at a first elevation in a z-direction defined perpendicular to the back surface. Respective terminals of the first and second line connectors can be positioned at a second elevation in the z-direction spaced apart from the first elevation. Terminals of the first and second load connectors can be positioned at a third elevation in the z-direction farther from the first elevation than is the second elevation. The neutral line connector can extend from a fourth elevation in the z-direction to a fifth elevation in the z-direction.

A printed circuit board assembly (PCBA) can be within the interior space of the housing. The PCBA can include a controller configured to control each of the main switching device and the plurality of branch switching devices independently to switch back and forth between ON and OFF states. A first sensor can be operatively connected to feedback signals indicative of current in the first load connector to the controller for feedback based control of the main switching device. A second sensor can be operatively connected to feedback signals indicative of current in the second load connector to the controller for feedback based control of the main switching device. At least one communication port can be included. The at least one communication port can be configured for connection to devices outside of the housing. The at least one communication port can be operatively connected to the PCBA for data exchange between the PCBA and an external device.

An electrical panel includes a panel housing defining a back surface and including a first line and a second line. An interior in the panel housing. A microgrid interconnect device (MID) in the panel housing between the interior and the back surface, wherein the MID is connected in electrical series between the interior and the first and second lines of the panel housing. The MID includes a plurality of branch switching devices for control of branch circuits.

A plurality of branch devices can be operatively connected to the interior to control individual circuits respectively connected to the branch devices by respective load wires. Each branch device in the plurality of branch devices can be in electrical series with at least one of the branch switching devices of the plurality of branch switching devices of the MID. The MID can include a main switching device. A first line connector can be electrically connected to the main switching device and to the first line of the panel housing. A second line connector can be electrically connected to the main switching device and to the second line of the panel housing. A first load connector can be electrically connected to the main switching device and to a first line bus of the interior. A second load connector can be electrically connected to the main switching device and to a second line bus of the interior. The main switching device can be configured to switch back and forth between an ON state and an OFF state. In the ON state, the main switching device can electrically connect the first line connector to the first load connector and can electrically connect the second line connector to the second load connector. In the OFF state, the main switching device can electrically isolate the first line connector from the first load connector and can electrically isolate the second line connector from the second load connector.

An MID housing can be included. The main switching device can be in an interior space of the MID housing. Each of the first load connector, the second load connector, the first line connector, and the second line connector can extend from an exterior space, through the MID housing, and into the interior space of the MID housing. A neutral line connector can be mounted to the MID housing and can be electrically connected to a neutral line of the panel housing and to a neutral bus of the interior. The MID housing can include a back surface at a first elevation in a z-direction defined perpendicular to the back surface. Respective terminals of the first and second line connectors can be positioned at a second elevation in the z-direction spaced apart from the first elevation. Terminals of the first and second load connectors can be positioned at a third elevation in the z-direction farther from the first elevation than is the second elevation. The neutral line connector can extend from a fourth elevation in the z-direction to a fifth elevation in the z-direction. The MID housing can have a thickness in the z-direction, not including the branch switching devices, of about 33 mm, width lateral to the z-direction, not including the branch switching devices, of about 180 mm, and a length lateral to the width and to the z-direction of about 500 mm. An aspect ratio of the thickness to the length can be about 35/500 or less. The branch switching devices can be lateral of the interior.

A printed circuit board assembly (PCBA) can be included within the interior space of the MID housing. The PCBA can include a controller configured to control the main switching device to switch the main switching device and the plurality of branch switching devices individually back and forth between the ON state and the OFF state. A first sensor can be operatively connected to feedback signals indicative of current in the first load connector to the controller for feedback based control of the main switching device. A second sensor can be operatively connected to feedback signals indicative of current in the second load connector to the controller for feedback based control of the main switching device. At least one communication port can be configured for connection to devices outside of the MID housing. The at least one communication port can be operatively connected to the PCBA for data exchange between the PCBA and an external device.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic perspective view of an embodiment of an electrical panel for retrofitting in accordance with the present disclosure, showing the panel housing and deadfront prior to retrofitting to include a microgrid interconnect device (MID);

FIG. 2 is a schematic perspective view of the electrical panel of FIG. 1, showing the deadfront and interior removed from the panel housing;

FIG. 3 is a is a schematic perspective view of the electrical panel of FIG. 2, showing the MID mounted in the panel housing;

FIG. 4 is a schematic perspective view of the MID of FIG. 3, showing the internal components inside the MID housing;

FIG. 5 is a schematic perspective view of the MID of FIG. 3, showing the connectors of the MID;

FIG. 6 is a schematic perspective view of the electrical panel of FIG. 3, showing the interior installed over the MID;

FIG. 7 is a schematic perspective view of the electrical panel of FIG. 6, showing connection of the branch breaker devices connected to the interior and showing connection of the communication port or ports of the MID to the panel housing for data connection to external devices;

FIG. 8 is a schematic perspective view of a portion of the electrical panel of FIG. 7, showing connection of a 1-pole branch breaker device connected to the interior and to one of the branch switching devices of the MID;

FIG. 9 is a schematic perspective view of a portion of the electrical panel of FIG. 7, showing connection of a 2-pole branch breaker device connected to the interior and to two of the branch switching devices of the MID; and

FIG. 10 is a schematic perspective view of the electrical panel of FIG. 7, showing a deadfront mounted over the interior to enclose the interior and MID inside the panel housing.

### DETAILED DESCRIPTION OF THE PREFERRED EMBODIMENTS

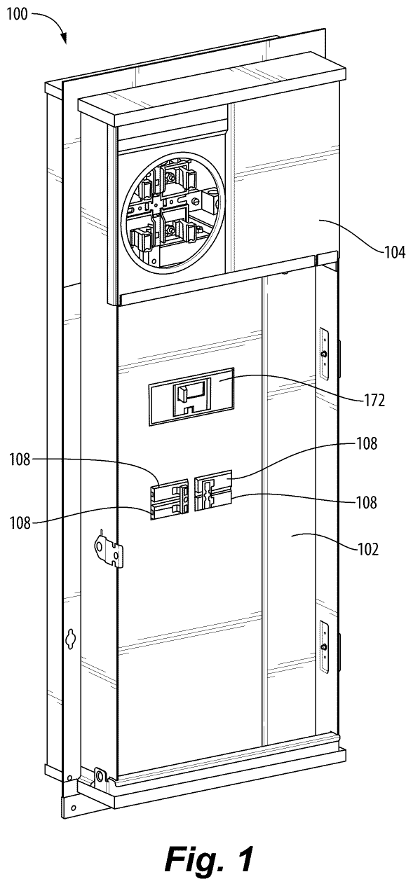

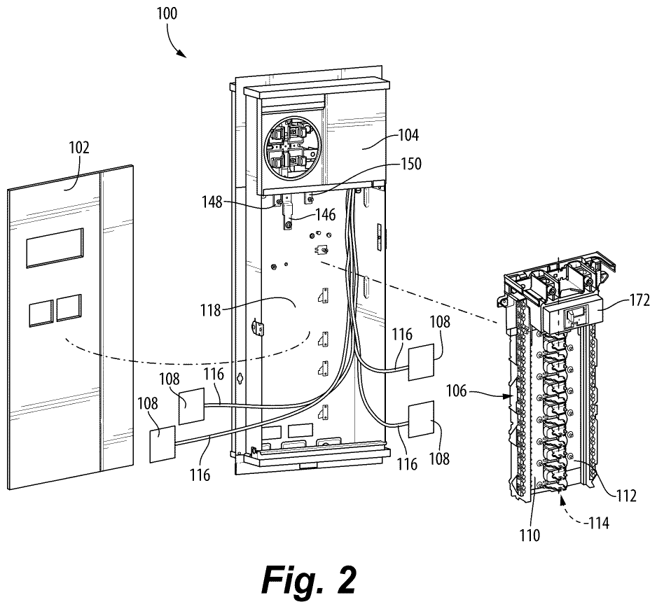

Reference will now be made to the drawings wherein like reference numerals identify similar structural features or aspects of the subject disclosure. For purposes of explanation and illustration, and not limitation, a partial view of an embodiment of an electrical panel for retrofitting in accordance with the disclosure is shown in FIG. 1 and is designated generally by reference character 100. Other embodiments of systems in accordance with the disclosure, or aspects thereof, are provided in FIGS. 2-10, as will be described. The systems and methods described herein can be used in new installations or to retrofit legacy electrical panels such as common service entrance device (CSED) panels, indoor/outdoor load centers, or the like, to include a microgrid interconnect device (MID) and individual branch circuit control.

A method of retrofitting an electrical panel 100 can start with an electrical panel 100 such as a Square D CSED panel, an indoor/outdoor load center, or the like, as shown in FIG. 1. As shown in FIG. 2, the method includes removing a legacy deadfront 102 from the electrical panel housing 104 to provide access to an interior 106 of the electrical panel 100, as indicated by the dashed line to the left in FIG. 2. The method includes unplugging a plurality of branch devices 108, e.g. circuit breakers, from the buses 110, 112, 114 of the interior 106, e.g. letting the branch devices 108 hang by their load wires 116 off to the side of the back surface 118 of the panel housing 104. The method includes removing the interior 106 from the panel housing 104 as indicated by the dashed line to the right in FIG. 2.

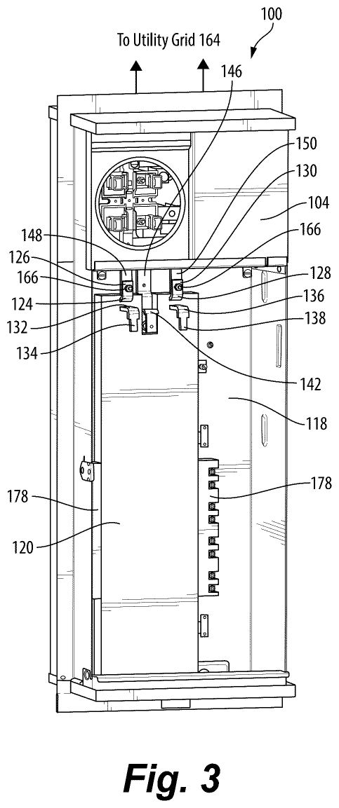

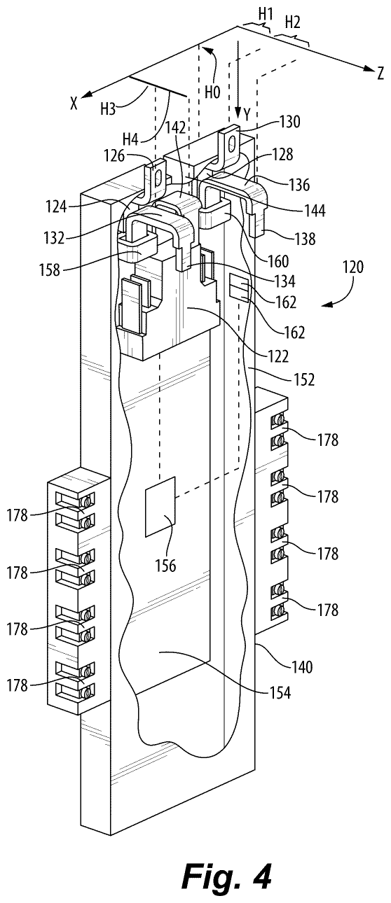

With reference now to FIG. 3, the method includes installing a microgrid interconnect device (MID) 120 into the panel housing 104 into a position formerly occupied by the interior 106. As shown in FIG. 4, the MID 120 includes a main switching device 122, e.g. a 200 A relay. A first line connector 124 is electrically connected to the main switching device 122. A second line connector 128 is electrically connected to the main switching device 122. A first load connector 132 is electrically connected to the main switching device 122. A second load connector 136 is electrically connected to the main switching device 122. The main switching device 122 is configured to switch back and forth between an ON state and an OFF state. In the ON state, the main switching device 122 electrically connects the first line connector 124 to the first load connector 132 and electrically connects the second line connector 128 to the second load connector 136. In the OFF state, the main switching device 122 electrically isolates the first line connector 124 from the first load connector 132 and electrically isolates the second line connector 128 from the second load connector 136.

With continued reference to FIGS. 3-4, the MID 120 includes an MID housing 140. The main switching device 122 is in an interior space of the housing 140. Each of the first line connector 124, and the second line connector 128, the first load connector 132, the second load connector 136, extends from an exterior space, through a wall of the housing 140, and into the interior space of the housing 140. A neutral line connector 142 is mounted to the housing 140 in a notch 144 of the housing 140 between the first and second load connectors 132, 136.

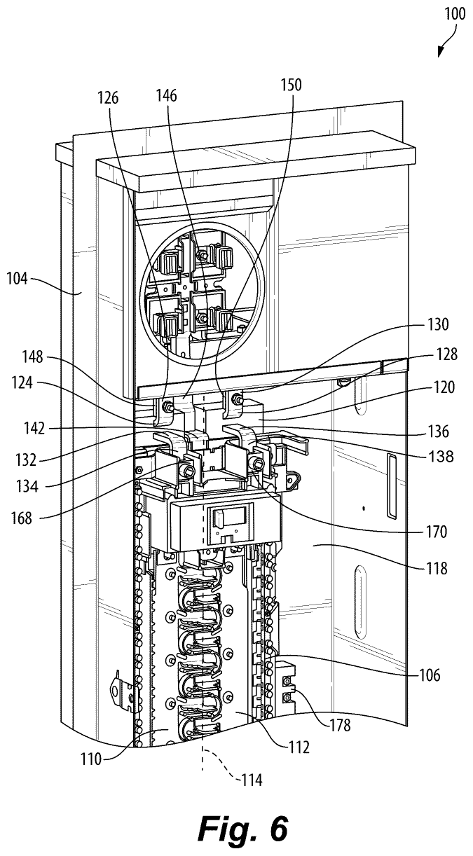

With reference to FIG. 4, the housing 140 includes a back surface 152 at an elevation H0 in a z-direction defined perpendicular to the back surface 152, e.g. H0=0. Respective terminals 126, 130 of the first and second line connectors 124, 128 are positioned at a first elevation H1 in the z-direction spaced apart from the elevation H0. Terminals 134, 138 of the first and second load connectors 132, 136 are positioned at an elevation H2 in the z-direction farther from the elevation H0 of the back surface 152 than is the elevation H1. The neutral line connector 142 extends from an elevation H3 in the z-direction to an elevation H4 in the z-direction that is farther from the back surface 152 than is the elevation H3. This elevation H2 above the elevation H1 and of elevation H4 above elevation H3 allows for the elevation of the interior 106 when it is reinstalled as described below with reference to FIG. 6 relative to its original elevation before retrofitting.

Referring still to FIG. 4, a printed circuit board assembly (PCBA) 154 is included within the interior space of the housing 140. The PCBA 154 includes a controller 156 operatively connected to control the main switching device 122 to switch the main switching device 122 back and forth between the ON and OFF states. A first current sensor 158 is operatively connected to feedback signals indicative of current in the first load connector 132 to the controller 156 for feedback based control of the main switching device 122. A second current sensor 160 is operatively connected to feedback signals indicative of current in the second load connector 136 to the controller 156 for feedback based control of the main switching device 122. At least one communication port 162 is included, operatively connected for data input/output of the PCBA 154 and controller 156, e.g., for uploading commands and/or programming into the PCBA 154 for the controller 156, downloading usage data or the like from the PCBA 154. The at least one communication port 162 is mounted to an opening in the housing 140 for connection to external devices outside of the housing 140. The MID 120 includes a plurality of branch switching devices 178, e.g. 90 A relays, operatively connected to the PCBA 154 of the MID 120 that controls the main switching device 122 control individual branch circuits between ON and OFF states. The branch switching devices 178 can control the branch circuits individually. There are four branch switching devices 178 shown on each lateral side of the MID 120, however those skilled in the art will readily appreciate that any suitable number of branch switching devices 178 can be included.

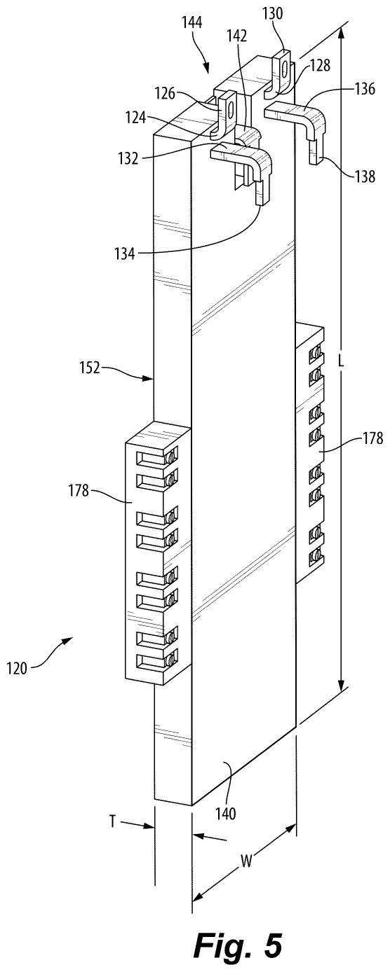

With reference to FIG. 5, the housing 140 has a thickness T in the z-direction of about 33 mm, not including the thickness of the branch switching devices 178, a width W lateral to the z-direction of about 180 mm, not including the width of the branch switching devices 178, and a length L lateral to the width W and to the z-direction of about 500 mm. An aspect ratio of the thickness to the length can be about 35/500 or less. This envelope accommodates the MID 120 in the space described below between the back surface 118 (labeled in FIG. 2) of the panel housing 104 and the interior 106 after the retrofit for a CSED. Legacy CSEDs are deep enough in the z-direction to allow an elevated interior 106. Those skilled in the art will readily appreciate that any suitable dimensions can be used, and that an MID as disclosed herein can be modified in envelop as needed to fit any suitable electrical panel as needed.

With reference again to FIG. 3, the method includes connecting first and second lines 148, 150 of the panel housing 104 and a neutral line 146 of the panel housing 104 to the MID 120. The lines 148, 150, in turn connect to a utility grid 164. The terminal 126 of the first line connector 124 is electrically and mechanically connected to a first line 148 of an electrical panel, e.g. with a fastener 166. A terminal 130 of the second line connector 128 of the MID 120 is electrically and mechanically connected to the second line 150 of the electrical panel 100, e.g. with a fastener 166.

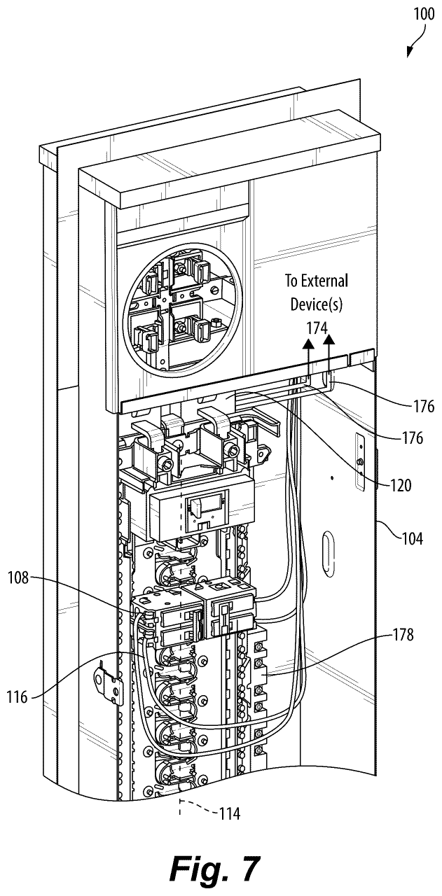

With reference to FIG. 6, the method includes installing the interior 106 onto the MID 120, with the MID 120 physically located between the interior 106 and a back surface 118 of the panel housing 104. The method includes connecting respective busses 110, 112, 114 of the interior 106 to the MID 120, so the MID 120 is connected in electrical series between the busses 110, 112, 114 of the interior 106 and the first, second, and neutral lines 148, 150, 146 in of the panel housing 104, respectively. A terminal 134 of the first load connector 132 is electrically and mechanically connected to the first line bus 110 of the interior 106, e.g. using a lug 168 of the interior 106. The first line connector 124 thereby electrically connects the main switching device 122 to the first line 148 of the panel housing 104, and to the first line bus 110 when the main switching device 122 is in the ON state. A terminal 138 of the second load connector 136 is mechanically and electrically connected to the second line bus 112 of the interior 106, e.g. using the lug 170 of the interior 106. The second line connector 128 thereby electrically connects the main switching device 122 to the second line 150 of the panel housing 104, and to the second line bus 112 when the main switching device 122 is in the ON state. The neutral line connector 142 is connected to a neutral line 146 of the electrical panel 100 and to the neutral bus 114 of the interior 106, e.g. for grounding respective circuits of the branch devices 108 of FIG. 7.

With reference now to FIG. 7, after installing the interior 106 onto the MID 120, the method includes re-installing the branch devices 108 to the busses 110, 112, 114 (labeled in FIG. 6) of the interior 106. The wires 116 shown in FIG. 7 can be removed from the branch devices 108 before or after remounting the branch devices 108 to the interior 106. With the interior 106 installed over the MID 120, the branch switching devices 178 extend lateral of the interior 106 in the direction of the width W identified in FIG. 5.

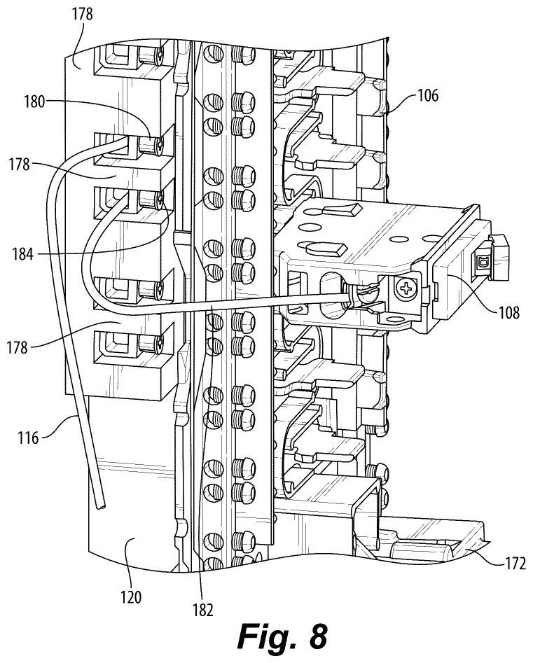

With reference now to FIG. 8, one of the branch switching devices 178 of the MID 120 is connected in electrical series with a branch breaker device 108 of the interior 106 for control of a branch circuit connected via the respective wire 116. Connecting each branch switching devices 178 of the MID 120 in electrical series with a respective branch breaker device 108 of the interior 106 includes disconnecting a first wire 116 connecting a respective branch circuit to the branch breaker device 108 (as shown in FIG. 7) from a lug of the branch breaker device 108. That same wire 116 is then connected to a first lug 180 of a respective one of the branch switching devices 178. A jumper wire 182 is connected from a second lug 184 of the respective branch switching device 178 to the lug of the branch breaker device 108. The lugs 180, 184 of the branch switching devices can be, e.g., 60 A lugs.

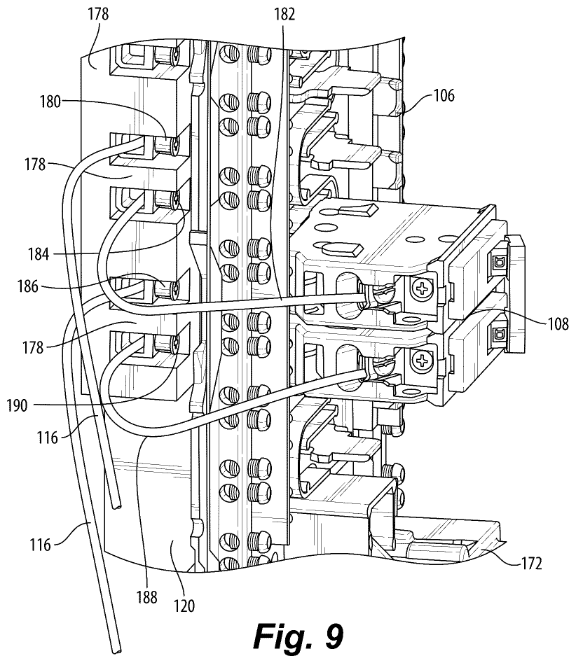

In the case of a 2-pole branch breaker device 108, the same process described above can be used as shown in FIG. 9 for the lugs 180, 184, the first wire 116, and the jumper wire 182. A second wire 116 can be moved from connecting to a second lug of the branch breaker device 108 to a first lug 186 of a second respective one of the branch switching devices 178. A second jumper wire 188 can then be connected from a second lug 190 of the second branch switching device 178 to the second lug of the branch breaker device 108. Thus whether the branch breaker device 108 is a 1-pole or 2-pole device, the branch switching device 178 of the MID is connected in electrical series with a branch breaker device 108 for control of the branch circuit.

With reference again to FIG. 7, the plurality of branch devices 108 are operatively connected to the interior 106 to control individual circuits respectively connected to the branch devices 108 by respective load wires 116, indicated in FIG. 7 prior to the wiring shown in FIGS. 8-9. The interior 106 includes a main switching device or breaker 172. The MID 120 is connected in electrical series between the first and second lines 148, 150 of the electrical panel 100 and the main switching device 172 of the interior 106. The main switching device 172 is in electrical series between the first and second load connectors 132, 136 and the first and second line busses 110, 112, respectively. This allows the MID 120 to disconnect the electrical panel 100 from the utility grid 164 (labeled in FIG. 3), when operating the interior 106 as an island separate from the utility grid 164. In island mode, the branch switching devices 178 can be individually controlled, e.g. to connect or disconnect generators, batteries, and other sources, as well as to connect and disconnect loads.

In order for grid power to be supplied to one of the branch circuits via the respective wire 116, the utility grid has to be connected to the lines 148, 150 of the electrical panel 100, the main breaker 172 needs to be in the ON state, the main switching device 122 (labeled in FIG. 4) of the MID 120 must be in the ON state, the respective branch breaker device 108 must be in the ON state, and finally, the respective branch switching device 178 must be in the ON state. Relative to the utility grid, the branch switching devices 178 are downstream of their respective branch breaker devices 108. Some branch breaker device positions on the busses 110, 112, 114 of the interior 106 do not have adjacent branch switching devices 178, e.g. for branch circuits where relay control is not needed. In those slots, branch breaker devices 108 can be connected directly from the interior 106 to the respective branch circuit load wires 116.

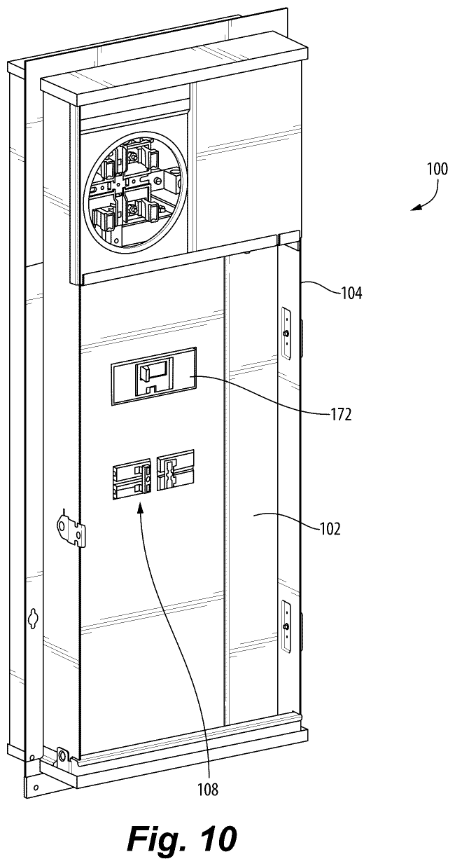

Referring still to FIG. 7, the method includes connecting an external device 174 to the at least one communication port 162 of the MID 120 (labeled in FIG. 4), e.g. using respective cables 176 for Ethernet, RS485, auxiliary, or the like. With the PCBA 154 (labeled in FIG. 4) connected in this way, the PCBA 154 can provide main sensing, main switching device 122 control, branch current sensing, and branch switching device 178 control, e.g. for digital and/or remote control of the branch circuits individually. After connecting respective busses 110, 112, 114 of the interior 106 to the MID 120 and re-installing the branch devices 108 to the busses 110, 112, 114 of the interior 106 as described above, the method includes re-installing the deadfront 102 or installing a new deadfront 102 to the panel housing 104, as shown in FIG. 10.

Systems and methods as disclosed herein provide potential benefits including the following. Systems and method disclosed herein can utilize valuable space that is effectively empty or wasted in a standard CSED panel. For standard utility allowance (SUA) or island mode battery life extension, the energy consumption of the mains (whole panel) and of high power circuits is needed to be known, and acted upon. The systems and method disclosed herein can manage all the energy measure, calculations, and control of circuits without additional hardware in the panel such as current transformers (CTs), a gateway, plug on relays or high cost remote control branch breakers.

The methods and systems of the present disclosure, as described above and shown in the drawings, provide for new installations or retrofitting legacy electrical panels such as common service entrance device (CSED) panels, indoor/outdoor load centers, or the like, to include a microgrid interconnect device (MID) and individual branch circuit control. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method of retrofitting an electrical panel comprising:
removing an interior from a panel housing of the electrical panel;
installing a microgrid interconnect device (MID) into the panel housing into a position formerly occupied by the interior;
connecting first and second lines and a neutral line of the panel housing to the MID;
installing the interior onto the MID, with the MID between the interior and a back surface of the panel housing;
connecting busses of the interior to the MID; and
connecting a branch switching device of the MID in electrical series with a branch breaker of the interior for control of a branch circuit.

2. The method as recited in claim 1, further comprising:
prior removing the interior from the panel housing, unplugging a plurality of branch devices from the buses of the interior; and
after installing the interior onto the MID, re-installing the branch devices to the busses of the interior, wherein each of the branch devices is a branch breaker, wherein connecting the branch switching device of the MID in electrical series with the branch breaker of the interior includes for each branch breaker:
disconnecting a first wire connecting a respective branch circuit to the branch breaker from the branch breaker;
connecting the first wire to a first lug of a respective branch switching device of the MID; and
connecting a jumper wire from a second lug of the respective branch switching device to the branch breaker.

3. The method as recited in claim 1, wherein the branch breaker is a 2-pole circuit breaker, wherein connecting the branch switching device of the MID in electrical series with a branch breaker includes:
disconnecting a first wire connecting the branch circuit to the branch breaker from a first lug of the branch breaker;
connecting the first wire to a first lug of a first branch switching device of the MID;
connecting a first jumper wire from a second lug of the first branch switching device of the MID to the first lug of the branch breaker;
disconnecting a second wire connecting the branch circuit to the branch breaker from a second lug of the branch breaker; and
connecting the second wire to a first lug of a second branch switching device of the MID;
connecting a second jumper wire from a second lug of the second branch switching device of the MID to the second lug of the branch breaker.

4. The method as recited in claim 1, further comprising connecting an external device to a communication port of the MID.

5. The method as recited in claim 1, further comprising:
prior to removing the interior from the panel housing, removing a deadfront from the panel housing to provide access to the interior of the electrical panel; and
after connecting respective busses of the interior to the MID, re-installing the deadfront or installing a new deadfront to the panel housing.

6. A microgrid interconnect device (MID) comprising:
a main switching device;
a first line connector electrically connected to the main switching device and configured to connect to a first line of an electrical panel;
a second line connector electrically connected to the main switching device and configured to connect to a second line of the electrical panel;
a first load connector electrically connected to the main switching device and configured to connect to a first line bus of an interior of the electrical panel; and
a second load connector electrically connected to the main switching device and configured to connect to a second line bus of the interior;
wherein the main switching device is configured to switch between an ON state and an OFF state,
wherein in the ON state, the main switching device electrically connects the first line connector to the first load connector and electrically connects the second line connector to the second load connector, and
wherein in the OFF state, the main switching device electrically isolates the first line connector from the first load connector and electrically isolates the second line connector from the second load connector, and further comprising:
a plurality of branch switching devices operatively connected to the main switching device to control individual branch circuits.

7. The MID as recited in claim 6, further comprising a housing, wherein the main switching device is in an interior space of the housing, wherein each of the first load connector, the second load connector, the first line connector, and the second line connector extends from an exterior space, through the housing, and into the interior space of the housing.

8. The MID as recited in claim 7, further comprising a neutral line connector mounted to the housing configured to connect to a neutral line of the electrical panel to a neutral bus of the interior.

9. The MID as recited in claim 8, wherein the housing includes a back surface at a first elevation in a z-direction defined perpendicular to the back surface, wherein respective terminals of the first and second line connectors are positioned at a second elevation in the z-direction spaced apart from the first elevation, wherein terminals of the first and second load connectors are positioned at a third elevation in the z-direction farther from the first elevation than is the second elevation, and wherein the neutral line connector extends from a fourth elevation in the z-direction to a fifth elevation in the z-direction.

10. The MID as recited in claim 8, further comprising:
a printed circuit board assembly (PCBA) within the interior space of the housing, wherein the PCBA includes a controller configured to control each of the main switching device and the plurality of branch switching devices independently to switch back and forth between ON and OFF states;
a first sensor operatively connected to feedback signals indicative of current in the first load connector to the controller for feedback based control of the main switching device; and
a second sensor operatively connected to feedback signals indicative of current in the second load connector to the controller for feedback based control of the main switching device.

11. The MID as recited in claim 10, further comprising at least one communication port configured for connection to devices outside of the housing, wherein the at least one communication port is operatively connected to the PCBA for data exchange between the PCBA and an external device.

12. An electrical panel comprising:
a panel housing defining a back surface and including a first line and a second line;
an interior in the panel housing; and
a microgrid interconnect device (MID) in the panel housing between the interior and the back surface, wherein the MID is connected in electrical series between the interior and the first and second lines of the panel housing and includes a plurality of branch switching devices for control of branch circuits.

13. The electrical panel as recited in claim 12, further comprising a plurality of branch devices operatively connected to the interior to control individual circuits respectively connected to the branch devices by respective wires, wherein each branch device in the plurality of branch devices is in electrical series with at least one of the branch switching devices of the plurality of branch switching devices of the MID.

14. The electrical panel as recited in claim 12, wherein the MID includes:
a main switching device;
a first line connector electrically connected to the main switching device and to the first line of the panel housing;
a second line connector electrically connected to the main switching device and to the second line of the panel housing;
a first load connector electrically connected to the main switching device and to a first line bus of the interior; and
a second load connector electrically connected to the main switching device and to a second line bus of the interior;
wherein the main switching device is configured to switch back and forth between an ON state and an OFF state,
wherein in the ON state, the main switching device electrically connects the first line connector to the first load connector and electrically connects the second line connector to the second load connector, and
wherein in the OFF state, the main switching device electrically isolates the first line connector from the first load connector and electrically isolates the second line connector from the second load connector.

15. The electrical panel as recited in claim 14, further comprising an MID housing, wherein the main switching device is in an interior space of the MID housing, wherein each of the first load connector, the second load connector, the first line connector, and the second line connector extends from an exterior space, through the MID housing, and into the interior space of the MID housing.

16. The electrical panel as recited in claim 15, further comprising a neutral line connector mounted to the MID housing and electrically connected to a neutral line of the panel housing and to a neutral bus of the interior.

17. The electrical panel as recited in claim 16, wherein the MID housing includes a back surface at a first elevation in a z-direction defined perpendicular to the back surface, wherein respective terminals of the first and second line connectors are positioned at a second elevation in the z-direction spaced apart from the first elevation, wherein terminals of the first and second load connectors are positioned at a third elevation in the z-direction farther from the first elevation than is the second elevation, and wherein the neutral line connector extends from a fourth elevation in the z-direction to a fifth elevation in the z-direction.

18. The electrical panel as recited in claim 16, wherein the MID housing has a thickness not including the branch switching devices in the z-direction, width lateral to the z-direction not including the branch switching devices, and a length lateral to the width and to the z-direction, with an aspect ratio of the thickness to the length being about 35/500 or less.

19. The electrical panel as recited in claim 16, further comprising:
a printed circuit board assembly (PCBA) within the interior space of the MID housing, wherein the PCBA includes a controller configured to control the main switching device and the plurality of branch switching devices individually to switch the main switching device back and forth between ON and OFF states;
a first sensor operatively connected to feedback signals indicative of current in the first load connector to the controller for feedback based control of the main switching device; and
a second sensor operatively connected to feedback signals indicative of current in the second load connector to the controller for feedback based control of the main switching device.

20. The electrical panel as recited in claim 19, further comprising at least one communication port configured for connection to devices outside of the MID housing, wherein the at least one communication port is operatively connected to the PCBA for data exchange between the PCBA and an external device.
